(19) United States
(12) Patent Application Publication
(10) Pub. No.: US 2004/0159359 A1
(43) Pub. Date: Aug. 19, 2004

(54) Apparatus and method for sealing the junction where a branch line joins a header

(75) Inventor: Kurt Schmidt, Zollikon (CH)

Correspondence Address: OLIFF & BERRIDGE, PLC, P.O. BOX 19928, ALEXANDRIA, VA, 22320, US

(73) Assignee: RS TECHNIK AG, Gruningen (CH)

(21) Appl. No.: 10/774,609

(22) Filed: Feb. 10, 2004

(30) Foreign Application Priority Data
Feb. 13, 2003 (EP) 03 003 328.6

(51) Int. Cl. F16L 55/18

(52) U.S. Cl. 138/98; 138/97; 405/150.1; 156/287; 156/294

(57) ABSTRACT

An apparatus for sealing a junction where a branch line joins a header having a packer. The packer has an inflatable packer sleeve for the header and an inflatable side sleeve for the branch line that protrudes from said header in the inflated state. A tunnel passes from an end of the packer through an interior space to a collar, in which a feed line for introducing sealing material runs to the junction at the collar. In a deflated state, the side sleeve is inverted in the interior space of the packer sleeve. When the packer is placed, the packer sleeve to which compressed air is admitted comes to rest against the inside wall of the header and, subsequently, the side sleeve moves into the branch line by inversion.

### BACKGROUND OF THE INVENTION

1. Field of Invention

The present invention relates to an apparatus and method for repair of pipes. More specifically, the invention relates to a device and method for sealing the junction where a branch line joins a header.

2. Description of Related Art

There are various known devices and methods for sealing the junction where a branch line joins a header which is not accessible on foot. Such sealing of a branch line into a header, also known as stub-in or renewed stub-in, may be necessary, for example, if the junction has become defective, such as in the case of wastewater pipelines due to invasive root growth or other adverse effects that have led to material crumbling away or breaking free. Furthermore, it may be necessary after introducing an inliner into the header and hardening of the same to mill it out at the junction and to seal the junction and provide it with a good flow profile in order that no parts can attach themselves.

WO 95/27167, for example, discloses how a dimensionally stable but flexurally elastic shuttering sleeve, for the shuttering of a main pipeline, is introduced into the main pipeline by means of a robot vehicle that can travel along pipes. The shuttering sleeve is brought into the correct rotational position at the junction of a branch line and made to expand, so that it fits stably in the main pipeline. The shuttering sleeve has a clearance for an expandable rubber balloon, which is likewise placed by means of the robot vehicle and inflated in such a way that it closes off the space between the clearance in the shuttering sleeve of the branch line and the broken-free soil at the junction. Furthermore, the sleeve has clearances for feeding a hardening mortar, preferably epoxy mortar, into said space.

A further device and a method for sealing the junction where a pipeline joins a header is disclosed in EP-A-0 674 132. The device has a shuttering plate, which can be brought through the header to the location that is to be sealed by means of a self-propelled robot vehicle. Arranged on the shuttering plate are telescopic supports, which are extended after the positioning of the shuttering plate. An inflatable balloon is brought into place through a clearance in the shuttering plate for sealing purposes. A sealant is injected into the space delimited by the balloon, the shuttering plate and the broken-free soil. The shuttering plate with the supports and the rubber balloon remains in the pipeline until the sealant has hardened. The robot vehicle can be decoupled from the parts remaining in the pipeline for hardening purposes, making it available for the repair of further junctions.

### SUMMARY OF THE INVENTION

An exemplary embodiment of the invention provides a device that is extremely simple in construction and easy to handle for sealing the junction where a branch line joins a header which does not allow for access on foot.

Exemplary embodiments of the invention may include an inflatable packer sleeve for the header and an inflatable side sleeve for the branch line that protrudes from said header in the inflated state. In an exemplary embodiment, a hat-shaped inflatable side sleeve may be provided. Thus, it is possible for the junction that is to be renewed to be sealed with the simplest means and in an easy manner.

The feeding of the sealing material is aided by an externally accessible tunnel which is intended for receiving a feed line for the sealing material and at the same time separates the interior space of the packer sleeve and side sleeve from the surroundings in a sealed manner.

### BRIEF DESCRIPTION OF THE DRAWINGS

The invention is explained in more detail on the basis of an exemplary embodiment, with reference to the following figures, wherein:

FIG. 1 schematically shows in a longitudinal section a portion of a tubular header with a branch line joining it, and a packer according to an exemplary embodiment of the invention fitted in said header and branch line;

FIG. 2 schematically shows in a horizontal section the header and the fitted packer according to an exemplary embodiment of the invention in plan view; and

FIG. 3 schematically shows the packer according to an exemplary embodiment of the invention with the packer sleeve and side sleeve deflated.

### DETAILED DESCRIPTION OF PREFERRED EXEMPLARY EMBODIMENTS

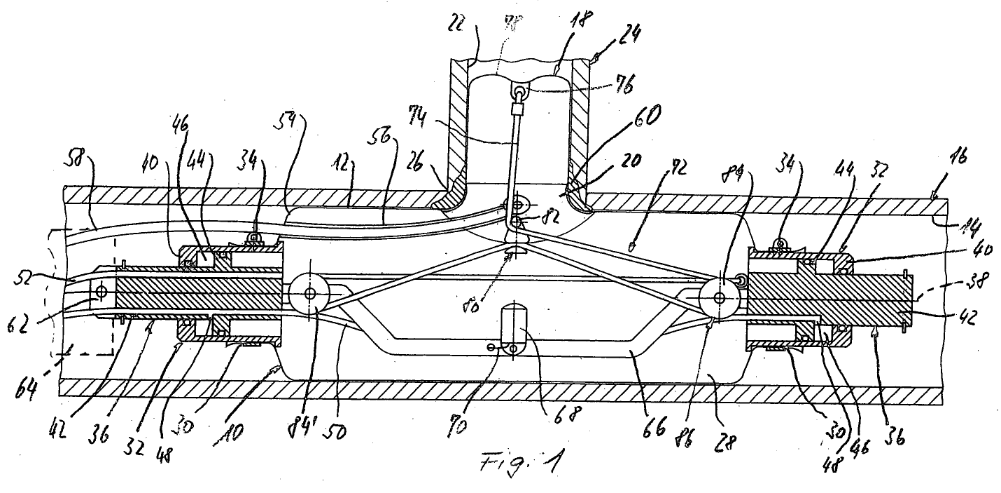

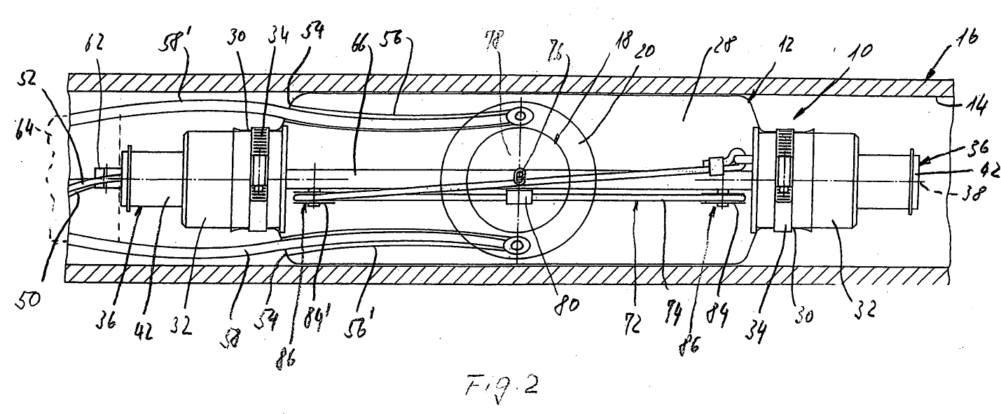

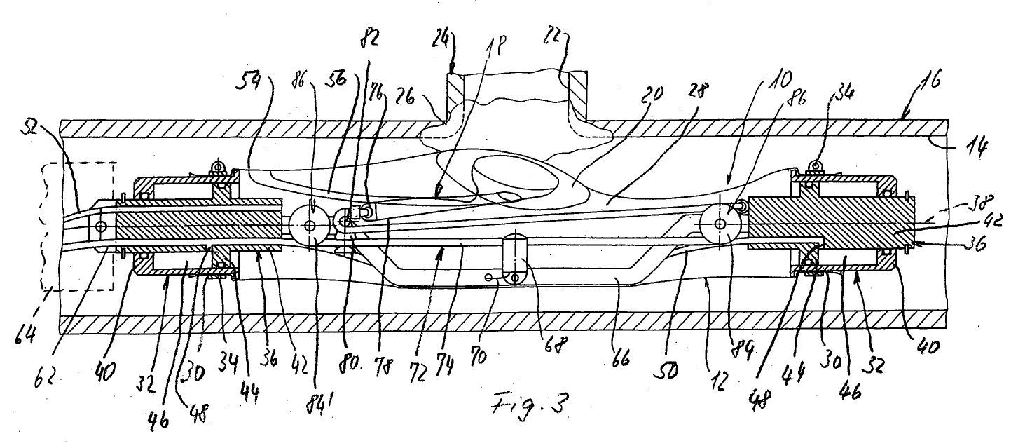

The packer 10, shown in FIGS. 1-3, has a tubular packer sleeve 12 of transparent elastic material. The sleeve 12 can be inflated by means of compressed air from a deflated state, shown in FIG. 3, whereby the sleeve 12 comes to rest in a sealing manner against the inside wall 14 of a header 16, as shown in FIGS. 1 and 2. The header 16 may be, for example, a header pipeline of a sewer system that is not accessible on foot.

The packer sleeve 12 includes a side sleeve 18. When viewed in the longitudinal direction of the packer sleeve 12, as in FIG. 1, fastened on the sleeve 12 about midway along is a hat-shaped side sleeve 18, which is preferably produced from the same material as the packer sleeve 12. A collar 20, which is preferably likewise produced from the same material, serves for fastening the side sleeve 18 on the packer sleeve 12. The collar 20 is peripherally connected in a sealed manner, for example by adhesive attachment or by means of welding, to the side sleeve 18 and attached in the same manner to the packer sleeve 12 along an edge region of the packer sleeve 12 adjoining a corresponding opening. It is also contemplated to connect the side sleeve 18 directly to the packer sleeve 12, for example by adhesive bonding or welding.

When inflated, the side sleeve 18 comes to rest in a sealing manner against the inside wall 22 of a branch line 24, which joins the header 16 at a junction 26, as shown in FIG. 1. The branch line 24 may be, for example, a wastewater pipeline coming from a building that is not accessible on foot and serves for wastewater disposal from the building. In the deflated state of the packer sleeve 12, the side sleeve 18 is in the inverted state in the interior space 28 delimited by the packer sleeve 12, as shown in FIG. 3.

The two axial ends 30 of the packer sleeve 12 each enclose an annular runner 32 and are fixed to the annular runner 32 in a sealing manner by means of a fastening means 34 that can be constricted in the circumferential direction. Each of the two runners 32 is mounted on a bearing element 36 assigned to it displaceably toward and away from each other in the axial direction of the packer 10, which is given by the longitudinal axis 38. The annular runners 32 have at their mutually averted ends, in a cup-like manner, a base 40, through which a shaft part 42 of the bearing element 36 passes. Located in a peripheral groove of the base 40 is an O-ring (not shown), bearing against the shaft part 42, for sealing the side facing the interior space 28 from the surroundings.

Protruding from the shaft part 42 in the circumferential direction and radially outward is a bead 44, which is peripherally provided with a groove in which a further O-ring (not shown) is arranged. The bead 44 and O-ring interact in a sealing manner with the inner side of the annular runner 32. The base 40 and the bead 44 delimit in the axial direction a displacing space 46, which is connected to a control line 50 via a bore 48 running in the radial direction. The control line 50 runs in the axial direction through the shaft part 42 of the bearing element 36, as shown on the left side of the packer 10 in FIGS. 1-3. The control line 50 passes through the interior space 28 to the shaft part 42 of the bearing element 36, as shown on the right side of the packer 10 in FIGS. 1-3, and in the latter as far as the related bore 48. If compressed air is admitted into the control line 50, the runners 32 are forced away from each other by the pressure in the displacing space 46, whereas the runners 32 can move toward each other if air is released from the control line 50.

Also running through the shaft part 42 of the bearing element 36, as shown on the left side of the packer 10 in FIGS. 1-3, is a compressed-air line 52, which opens out into the interior space 28 at the end face of the shaft part 42 facing the interior space 28. If compressed air is fed to the interior space through the compressed-air line 52, the packer sleeve 12 is inflated and the side sleeve 18 is introduced into the branch line 24 by inversion and likewise inflated. The compressed-air line 52 may be connected to the surroundings by means of a valve (not shown) for releasing air from the interior space 28.

From an end region 54 of the packer sleeve 12 that adjoins the runner 32, as shown on the left side of the packer 10 in FIGS. 1-3, two tunnels 56 run in the manner of a tube through the interior space 28 to the collar 20, where they open out into the surroundings. As shown in FIG. 2, the tunnels 56 are preferably provided symmetrically in relation to a longitudinal center plane, in which the longitudinal axis 38 and the axis of the side sleeve 18 in the inflated state lie. These tunnels 56 are intended for receiving a feed line 58 that carries a sealing material 60, which is to be introduced into the space delimited by the packer 10, the branch line 24 and the header 16, and possibly the soil, to seal the junction, and intended for receiving a venting line 58′. The air can escape through the venting line 58′ when the sealant 60 is injected.

In the inflated state of the packer sleeve 12 and of the side sleeve 18, the tunnel 56, which is preferably produced from the same material as the packer sleeve 12 and the side sleeve 18, comes to rest against the feed line 58 and the venting line 58′ and seals off the space, so that neither air nor the sealing material 60 can flow out into the tunnels 56.

As shown in FIGS. 1 and 2, in the inflated state of the packer sleeve 12, its end region with the opening of the tunnels 56 runs from the runner 32 virtually in a plane at right angles to the longitudinal axis 38. The feed line 58 and the venting line 58′ can consequently be taken past the runner 32 unproblematically, without hindering the packer sleeve 12 from resting properly against the inside wall 14.

The bearing element 36, as shown on the left side of the packer 10 in FIGS. 1-3, has at an outer free end a coupling 62, to allow the packer 10 to be coupled onto a generally known self-propelled robot vehicle 64, indicated by dashed lines. Located on the robot vehicle 64 are preferably cartridges containing the sealing material 60, the necessary drives and valves for the injection of the sealing material 60 and a controller for controlling the air in the control line 50 and compressed-air line 52.

Running in the interior space 28 is a tubular carrier 66, which firmly connects the shaft parts 42 of the two bearing elements 36 to each other. The carrier 66 is bent, so that in the middle region it runs in a direction away from the side sleeve 18 at a distance from the longitudinal axis 38. The outermost parts of the carrier 66 in the radial direction are approximately the same distance away from the longitudinal axis 38 as the radially outermost parts of the runners 32. Fastened approximately in the middle of the carrier 66, is a camera 68, the feed and signal lines 70 of which run in the carrier 66 to the bearing element 36, as shown on the left side of the packer 10 in FIGS. 1-3, and through the bearing element 36 to the robot vehicle 64. From the robot vehicle 64, the relevant lines lead to an above-ground control device, as known in connection with sewer renewal robot systems. In the field of view of the camera 68 is the collar 20. It is contemplated that the camera 68 may include a television camera.

The camera 68 may be pivotably fastened on the carrier 66. It is also contemplated to arrange a light source (not shown) on the carrier 66. This light source and the camera 68 are very well protected against soiling by the packer sleeve 12 and side sleeve 18.

Also present in the interior space 28 is an expander arrangement 72. In the exemplary embodiment of the invention, the expander arrangement 72 has a rubber-elastic drawing band 74, which is fixed at one end to a fastening tongue 76, which protrudes in the direction of the interior space 28 from approximately the middle of the wall region 78, when viewed in FIG. 1, closing off the side sleeve 18 at its free end. From the fastening tongue 76, the drawing band 74 runs to a deflecting element 80. From the deflecting element 80, after deflection about a deflecting pin 82, the band 74 runs to a first deflecting roller 84 of a pair of deflecting rollers 86 that is mounted freely rotatably on the carrier 66 alongside the bearing element 36, as shown on the right side of the packer 10 in FIGS. 1-3. After the deflection about the first deflecting roller 84, the drawing band 74 runs to the second deflecting roller 84′, which is mounted freely rotatably in a corresponding manner on the carrier 66 alongside the bearing element 36, as shown on the left side of the packer 10 in FIGS. 1-3. After deflection about this second deflecting roller 84′, the drawing band 74 leads to the bearing element 36, as shown on the right side of the packer 10 in FIGS. 1-3, at which the end on the band 74 side is fastened.

The deflecting element 80 is fastened on a portion of the drawing band 74 that extends between the first and second deflecting rollers 84, 84′, such that, in the inflated state of the packer sleeve 12 and side sleeve 18, the deflecting pin 82 is located approximately at the longitudinal axis of the side sleeve 18, as shown in FIGS. 1 and 2. When the packer sleeve 12 and the side sleeve 18 are deflated, the deflecting element 80 is at the second deflecting roller 84′, as shown in FIG. 3.

A two-component sealing material 60 which hardens very rapidly is preferably used in the device. In this case, cartridges (not shown) containing the two components and the mixing device, preferably a static mixer, are arranged on the robot vehicle 64. The packer 10 can be used repeatedly without exchanging the packer sleeve 12 with the side sleeve 18, since it can be peeled off from the sealing material 60, sealing the junction 26. The packer 10 can be used for the next application by, at most, fitting a new feed line 58 and possibly a venting line 58′ into the tunnel or tunnels 56. The feed line 58 and the venting line 58′ preferably have at their respective free ends a radially outwardly protruding, for example plate-like, sealing element, which also prevents sealing material 60 from coming into contact with the tunnel 56.

Operation of the packer 10 will now be described with reference to FIGS. 1-3. The packer 10, coupled to a robot vehicle 64, is introduced in the deflated state (FIG. 3) into the header 16 as far as the junction 26 where the branch line 24 joins. In FIG. 3, the feed line 58 and venting line 58′ are not shown for the sake of better overall clarity. However, the lines 58, 58′ are introduced into the tunnels 56 before the packer 10 is introduced into the header 16. During insertion into the header 16, the runners 32 are in their outer end position (FIG. 3). With the aid of the camera 68, the position of the packer 10 is checked and is set in the axial direction and in the rotational direction under remote control by means of the robot vehicle 64 in such a way that the collar 20 comes to lie exactly in front of the junction 26, as shown in FIG. 3. In FIG. 3, the missing material that has broken away at the junction 26 can also be seen.

Upon proper positioning of the packer 10, the control line 50 is connected to the surroundings and compressed air is admitted to the compressed-air line 52. As a result, the packer sleeve 12 is inflated until it is comes to rest against the inside wall 14 of the header 16, while at the same time the runners 32 move toward each other (FIG. 1). As a result of the increasing pressure in the interior space 28, the side sleeve 18 then moves, counter to the force of the drawing band 74, by inversion into the branch line 24 and comes to rest in a sealing manner against the inside wall 22 of the branch line 24, as shown in FIG. 1. The cartridges (not shown) with the sealing material 60 are then activated to introduce the material 60 through the feed line 58 into the space at the junction 26 which has been exposed because of broken-free material between the packer 10 and the header 16 or branch line 24 and possibly the soil. This entire operation is monitored and checked by means of the camera 68.

When the sealing material 60 has partly hardened, e.g., after about 10 minutes in the case of rapid-hardening two-component sealing materials 60, air is released from the compressed-air line 52 and pressure is admitted to the control line 50. As a result of the expander arrangement 72, the side sleeve 18 is withdrawn into the interior space 28 of the packer sleeve 12 by inversion and simultaneously peeled off from the inside wall 22 of the branch line 24. Then, assisted by the moving apart of the runners 32, the packer sleeve 12 comes free from the inside wall 14 of the header 16 and goes into the state shown in FIG. 3, wherein the packer sleeve 12 is in an extended position, after which the packer 10 is moved out of the header 16 with the aid of the robot vehicle 64. The branch line 24 is then stubbed again into the header 16.

If a sealing material 60 which requires a longer hardening time is used, it is contemplated that the coupling 62 and the coupling of the control line 50, compressed-air line 52, feed line 58 and venting line 58′ to the robot vehicle 64 are designed in such a way that the packer 10 can remain in the inflated state in the header 16 and the branch line 24 and then be deflated and removed from the header 16 at an appropriate time by renewed coupling to the robot vehicle 64.

In an exemplary embodiment of the invention, it is possible to dispense with the runners 32 and arrange the packer sleeve 12 such that it is fixed at its ends. In this case, it is advantageous to connect the compressed-air line 52 to a negative-pressure source for deflating the packer 10, in order to re-establish the deflated state with a small diameter of the packer 10.

In an exemplary embodiment of the invention, it is also contemplated to design the expander arrangement 72 differently or to provide different means, such as a winch, for drawing the side sleeve 18 back into the interior space 28 when the packer 10 is deflated.

Although in the example described and shown in FIGS. 1-3, the packer sleeve 12 and side sleeve 18 are formed from a transparent elastic synthetic material, it is contemplated to form only those portions of the sleeves 12, 18 that lie in the viewing region of the camera 68 in a transparent form.

In an exemplary embodiment of the invention, it is also contemplated to dispense with a venting line 58′ and to introduce the sealing material 60 by means of a second feed line 58.

If a venting line 58′ is used, it is advantageously closed, for example by means of a valve in the robot vehicle, in order to expose the fed-in sealing material 60 to higher pressure, which improves the quality of the stub-in. The point in time for closing the venting line can be established by the camera 68.

Finally, it should be mentioned that tunnels which run to the end region of the packer sleeve 12 may be disposed on either the right side or the left side of the packer 10 shown in FIGS. 1-3. A single tunnel 56 is also contemplated.

While the invention has been described in conjunction with exemplary embodiments, these embodiments should be viewed as illustrative, not limiting. Various modifications, substitutes, or the like are possible within the spirit and scope of the invention.

What is claimed is:

1. An apparatus for repairing the junction of a branch line and a header, comprising:
a packer comprising:
a first inflatable sleeve that delimits an interior space;
a second inflatable sleeve connected to the first inflatable sleeve;
a collar region, disposed at a transition between the first inflatable sleeve and the second inflatable sleeve;
at least one tunnel extending from an axial end region of the first inflatable sleeve within the interior space, to the collar region; and
at least one feed line disposed in the at least one tunnel for delivering a sealing material to a desired location.

2. The apparatus of claim 1, wherein the first inflatable sleeve contacts an interior wall of the header when in an inflated state and the second inflatable sleeve protrudes from the first inflatable sleeve and contacts an interior wall of the branch line when in an inflated state.

3. The apparatus of claim 1, wherein a camera is arranged in the interior space to determine a position of the packer in the header.

4. The apparatus of claim 3, wherein the camera is arranged to position the packer to align the second inflatable sleeve with the branch line.

5. The apparatus of claim 3, wherein the first inflatable sleeve and the second inflatable sleeve are comprised of a transparent material in a viewing region of the camera.

6. The apparatus of claim 1, wherein the first inflatable sleeve has opposing ends, each opposing end being sealed on an annular runner mounted on a bearing element, and the annular runners are displaceable in an axial direction.

7. The apparatus of claim 6, wherein the bearing elements are connected to each other by a carrier element disposed in the interior space.

8. The apparatus of claim 7, wherein the camera is arranged on the carrier element.

9. The apparatus of claim 6, wherein the bearing elements and the annular runners form a displacing space that can be connected to a positive-pressure source when the interior space delimited by the first inflatable sleeve is deflated in order to move the annular runners away from each other in the axial direction and to draw the first inflatable sleeve into an at least virtually extended position.

10. The apparatus of claim 1, wherein the packer further comprises, a drawing element disposed in the interior space, having a first end connected to the second inflatable sleeve for drawing the second inflatable sleeve into the interior space by inversion when the interior space delimited by the first inflatable sleeve is deflated.

11. The apparatus of claim 10, wherein the drawing element comprises an elastic band fastened to the second inflatable sleeve and is led around at least one roller, the drawing band having a deflecting element fastened thereto, around which a portion of the drawing band running between the second inflatable sleeve and the at least one roller is led.

12. The apparatus of claim 1, wherein the packer further comprises, a coupling element for coupling the packer to a vehicle.

13. A method of sealing the junction of a branch line and a header, comprising:
inserting a packer into a header in a deflated state;
positioning the packer with a branch line;
inflating a first inflatable sleeve and a second inflatable sleeve, wherein the first inflatable sleeve contacts an inside wall of the header when inflated, and the second inflatable sleeve contacts an inside wall of the branch line when inflated; and
injecting a sealing material into a space between the first inflatable sleeve and the wall and the second inflatable sleeve and the wall.

14. The method of claim 13, wherein positioning the packer comprises viewing a desired location through a camera disposed within the first inflatable sleeve.

15. The method of claim 13, wherein inflating the first inflatable sleeve and the second inflatable sleeve includes introducing compressed air into an interior space delimited by the first inflatable sleeve.
